(19) United States
(12) Patent Application Publication
(10) Pub. No.: US 2026/0029374 A1
(43) Pub. Date: Jan. 29, 2026

(54) APPARATUS AND METHOD FOR DETECTING DEFECT IN FOLDED PORTION OF CASING OF BATTERY CELL

(71) Applicant: SK ON CO., LTD., Seoul (KR)

(72) Inventors: Ung Bae PARK, Daejeon (KR); Oh Jae KWON, Daejeon (KR); Tae Gyun KIM, Daejeon (KR); Yu Ri SONG, Daejeon (KR); Jae Hee AHN, Daejeon (KR); Byoung Hak LEE, Daejeon (KR); Jung Taek LIM, Daejeon (KR); Young Jin JANG, Daejeon (KR)

(21) Appl. No.: 19/260,645

(22) Filed: Jul. 7, 2025

(30) Foreign Application Priority Data
Jul. 29, 2024 (KR) 10-2024-0100013

(51) Int. Cl. G01N 27/90; G01N 27/20; H01M 10/42

(52) U.S. Cl. CPC G01N 27/9006; G01N 27/20; H01M 10/4285

(57) ABSTRACT

An apparatus for detecting a defect in a folded portion of a casing of a battery cell, the apparatus includes a magnetic field outputter configured to output a magnetic field to the folded portion of the casing of the battery cell, a property measuring instrument configured to measure a property of the folded portion according to the magnetic field, and a controller configured to generate defect information of the folded portion, based on a measurement result of the property measuring instrument.

### CROSS-REFERENCE TO RELATED APPLICATION(S)

This patent document claims the priority and benefits of Korean Patent Application No. 10-2024-0100013 filed on Jul. 29, 2024, the disclosure of which is incorporated herein by reference in its entirety.

### TECHNICAL FIELD

The present disclosure relates to an apparatus and method for detecting a defect in a folded portion of a casing of a battery cell.

### BACKGROUND

Secondary batteries, unlike primary batteries, are convenient in that the secondary batteries can be charged and discharged, and thus have drawn a lot of attention as power sources for various mobile devices and electric vehicles. Such a secondary battery may include a battery cell. An electrode assembly, formed by stacking a cathode plate, an anode plate, and a separator or winding the cathode plate, the anode plate, and the separator in the form of a roll, may be accommodated in a case. A plurality of battery cells may be stacked in a predetermined direction and accommodated in a battery module, a battery pack, or a battery rack. The battery pack or battery rack may include a plurality of battery modules.

When the safety of even one of the plurality of battery cells, included in the battery module, the battery pack, or the battery rack, is not ensured, the safety of the entire set of battery cells may not be ensured. Accordingly, ensuring the safety of battery cells may be critical, and extensive research has been conducted on technologies for detecting defects in battery cells.

### SUMMARY

A folded portion of a casing of a battery cell may have a bent structure, and folding of the folded portion may generate stress in the folded portion. Accordingly, the probability of defect occurrence in the folded portion of the casing may be higher than that in other regions of the casing. A defect in the folded portion may degrade sealing performance of an electrode assembly of the casing, and such degradation in the sealing performance may lead to a decrease in the safety of the battery cell. Accordingly, it may be crucial to detect a defect in the folded portion.

The present disclosure provides an apparatus and method for efficiently detecting a defect (for example, a crack) in the folded portion of the casing of the battery cell.

According to an aspect of the present disclosure, there is provided an apparatus for detecting a defect in a folded portion of a casing of a battery cell, the apparatus includes a magnetic field outputter configured to output a magnetic field to the folded portion of the casing of the battery cell, a property measuring instrument configured to measure a property of the folded portion according to the magnetic field, and a controller configured to generate defect information of the folded portion, based on a measurement result of the property measuring instrument.

For example, the magnetic field outputter may be configured to output a magnetic field with respect to a plurality of coordinates of the folded portion according to movement of one of the magnetic field outputters and the battery cell.

For example, the folded portion may be positioned on one edge of the casing, and the magnetic field outputter may be configured to output a magnetic field with respect to a plurality of coordinates of the folded portion according to one-dimensional movement of one of the magnetic field outputters and the battery cell.

For example, the casing may include an embedded metal layer, and the defect information of the folded portion may include information on detection of a crack in the metal layer.

For example, the property according to the magnetic field may include sheet resistance of the folded portion, and the property measuring instrument may be configured to measure the sheet resistance of the folded portion.

For example, the magnetic field outputter may be configured to output a magnetic field with respect to a plurality of coordinates of the folded portion according to movement of one of the magnetic field outputter and the battery cell, and the controller may be configured to generate defect information of the folded portion, based on whether there is a coordinate having a sheet resistance value greater than a reference value, among the plurality of coordinates.

For example, the battery cell may be disposed between the magnetic field outputter and the property measuring instrument, and the property measuring instrument may have one surface on which the battery cell is disposed.

For example, the property according to the magnetic field may include an eddy current property of the folded portion according to the magnetic field, and the property measuring instrument may include a pickup coil having inductance for measuring the eddy current property of the folded portion according to the magnetic field.

For example, the property measuring instrument may further include a measurement circuit configured to measure a resonance frequency of LC resonance based on the inductance of the pickup coil.

According to another aspect of the present disclosure, there is provided a method of detecting a defect in a folded portion of a casing of a battery cell, the method including outputting a magnetic field to the folded portion of the casing, measuring a property of the folded portion according to the magnetic field, and generating defect information of the folded portion, based on the property according to the magnetic field.

For example, the folded portion may be positioned at an edge of the casing, and the outputting may include sequentially scanning a plurality of coordinates of the folded portion.

For example, the casing may include an embedded metal layer, and the defect information of the folded portion may include information on detection of a crack in the metal layer.

For example, the property according to the magnetic field may include sheet resistance of the folded portion, and the generating may include generating defect information of the folded portion, based on whether there is a coordinate having a surface resistance value greater than a reference value, among the plurality of coordinates.

For example, the property according to the magnetic field may include an eddy current property of the folded portion according to the magnetic field, and the measuring may include measuring inductance of a pickup coil for measuring the eddy current property of the folded portion according to the magnetic field.

For example, the property according to the magnetic field may include an eddy current property of the folded portion according to the magnetic field, and the measuring may further include measuring a resonance frequency of LC resonance based on inductance of a pickup coil for measuring the eddy current property of the folded portion according to the magnetic field.

### BRIEF DESCRIPTION OF DRAWINGS

Certain aspects, features, and advantages of the present disclosure are illustrated by the following detailed description with reference to the accompanying drawings.

FIG. 1 and FIG. 2 are diagrams illustrating an apparatus for detecting a defect in a folded portion of a casing of a battery cell according to an embodiment of the present disclosure.

FIG. 3 is a diagram illustrating a configuration in which an apparatus and method for detecting a defect in a folded portion of a casing of a battery cell output a magnetic field to generate an eddy current, according to an embodiment of the present disclosure.

FIG. 4 is a graph illustrating a result of measuring, by an apparatus and method for detecting a defect in a folded portion of a casing of a battery cell, sheet resistance at each coordinate of the folded portion, according to an embodiment of the present disclosure.

FIG. 5 is a circuit diagram illustrating a circuit structure of a magnetic field outputter included in an apparatus for detecting a defect in a folded portion of a casing of a battery cell according to an embodiment of the present disclosure.

FIG. 6 is a flowchart illustrating a method for detecting a defect in a folded portion of a casing of a battery cell according to an embodiment of the present disclosure.

FIG. 7 is a flowchart illustrating a configuration in which an apparatus and method for detecting a defect in a folded portion of a casing of a battery cell detect a crack in the folded portion, based on a result of measuring sheet resistance at each coordinate of the folded portion, according to an embodiment of the present disclosure.

FIG. 8 is a flowchart illustrating a configuration in an apparatus and method for detecting a defect in a folded portion of a casing of a battery cell detect a crack in the folded portion, based on a result of measuring inductance at each coordinate of the folded portion, according to an embodiment of the present disclosure.

### DETAILED DESCRIPTION

Features of the present disclosure disclosed in this patent document are described by example embodiments with reference to the accompanying drawings.

The present disclosure can be implemented in some embodiments to provide an apparatus and method for detecting a defect in a folded portion of a casing of a battery cell.

Before describing embodiments of the present disclosure, the words and terminologies used in the specification and claims should not be construed with common or dictionary meanings, but should be construed as meanings and conceptions coinciding with the spirit of the present disclosure under a principle that the inventor(s) may appropriately define the conception of the terminologies to explain the present disclosure in the optimum method. The same reference numerals in the drawings refer to components or elements performing substantially the same function. For ease of description and understanding, the same reference numerals may be used in different embodiments.

As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this disclosure, specify the presence of stated features, integers, operations, operations, elements, components or a combination thereof, but do not preclude the presence or addition of one or more other features, integers, operations, operations, elements, components, and/or groups thereof.

In addition, the terms “upper side,” “upper portion,” lower side,” “lower portion,” “side surface,” “front surface,” “rear surface” and the like are described based on a direction illustrated the drawings, and may be described differently when a direction of a corresponding object is changed.

In addition, as used herein, terms including an ordinal number such as “first” and “second” may be used to distinguish between components. The ordinal number is used to distinguish the same or similar components from each other, and the meaning of the term should not be limitedly interpreted due to the use of the ordinal number. For example, components combined with the ordinal number should not be construed as limiting the order of use or arrangement by the number. If necessary, respective ordinal numbers may be used interchangeably.

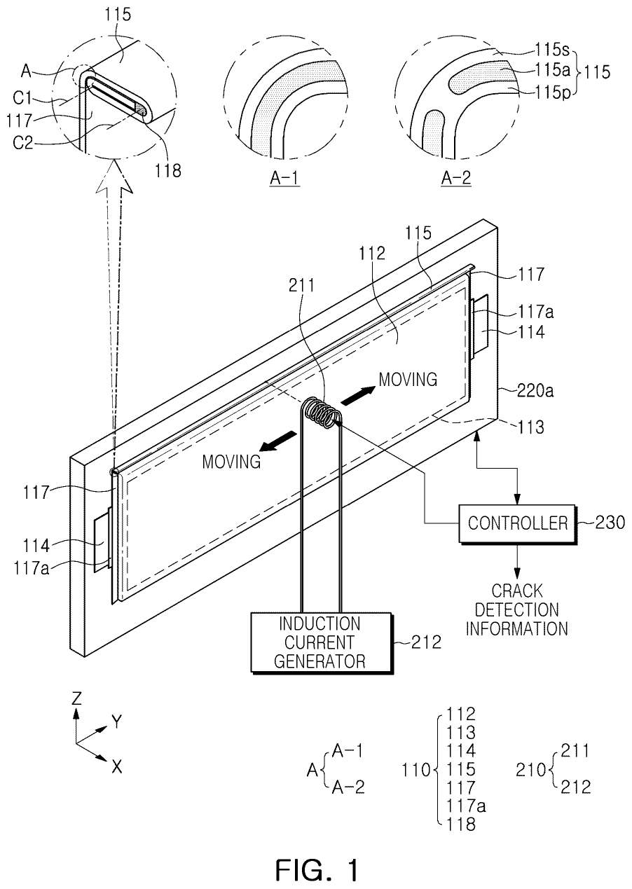

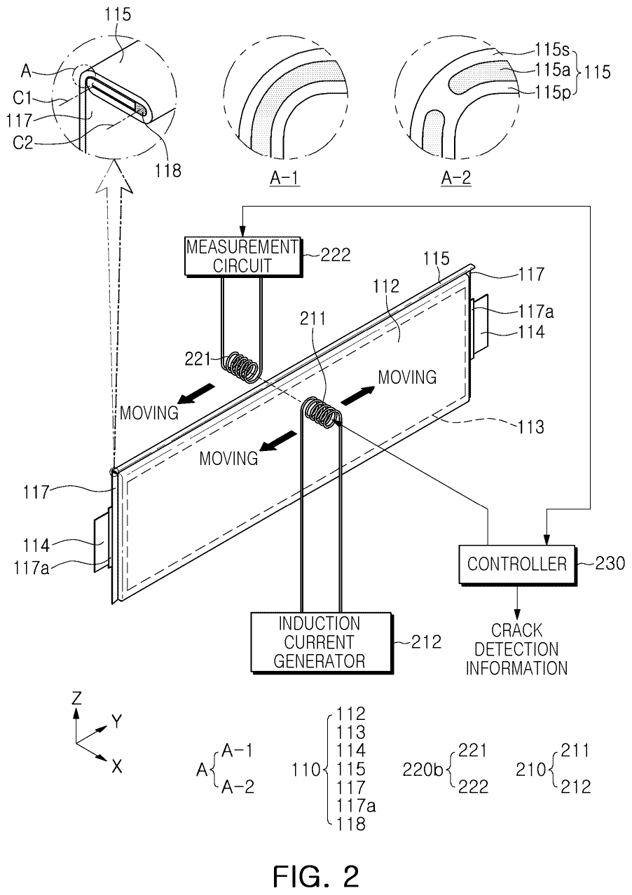

FIG. 1 and FIG. 2 are diagrams s illustrating an apparatus for detecting a defect in a folded portion of a casing of a battery cell according to an embodiment of the present disclosure. Referring to FIGS. 1 and 2, the apparatus according to an embodiment of the present disclosure may include a magnetic field outputter 210, property measuring instruments 220a and 220b, and a controller 230, and may detect a defect (for example, a crack in a metal layer 115a) of a folded portion 115 of a casing 112 of a battery cell 110.

The battery cell 110 may include at least one of a casing 112, an electrode assembly 113, an electrode lead 114, a folded portion 115, a terrace portion 117, a coupling portion 117a, and an adhesive member 118. For example, a battery module may include a plurality of battery cells 110, and a battery pack or a battery rack may include a plurality of battery modules. Hereinafter, a pouch-type battery cell 110 will be described, but a type of the battery cell 110 (for example, a cylindrical battery cell or a prismatic battery cell) is not limited to the pouch type, and a specific form of the pouch-type battery cell 110 may also vary depending on a design thereof.

The battery cell 110 may have a structure in which a cathode plate, an anode plate, a separator, and an electrolyte are disposed in the casing 112. The electrode assembly 113 may have a structure in which a plurality of cathode plate portions and a plurality of anode plate portions are alternately stacked, and the separator may be interposed between the cathode plate and the anode plate. The casing 112 may accommodate the electrode assembly 113 by three-dimensionally surrounding the electrode assembly 113.

The electrode lead 114 may provide an electrical connection path between the inside and the outside of the battery cell 110. A portion of the electrode lead 114 may be exposed to the outside of the casing 112, and may protrude in a Y-direction. A plurality of portions of the electrode lead 114 may be connected to the cathode plate and the anode plate of the electrode assembly 113, and may protrude in a +Y-direction and a-Y-direction, respectively, or may protrude only in one of the +Y-direction and the −Y-direction. Each of the plurality of cathode plate portions and the plurality of anode plate portions of the electrode assembly 113 may have an electrode tab to be connected to the electrode lead 114, and may be coupled to the electrode lead 114 while being coupled to each other at the coupling portion 117a.

The terrace portion 117 may refer to a remaining space in the casing 112 excluding the electrode assembly 113, and may be an edge portion of the casing 112. The terrace portion 117 may include a coupling portion 117a corresponding to an edge of the casing 112 in the Y-direction, and a folded portion 115 corresponding to an edge of the casing 112 in a +Z-direction. The terrace portion 117 may seal the electrode assembly 113 accommodated in the casing 112. For example, a region of the terrace portion 117 excluding the folded portion 115 may be a region formed by sealing the casing 112 using a method such as thermal fusion.

The folded portion 115 may be positioned at one edge of the casing 112. The folded portion 115 may be a region formed by folding one side of the casing 112. The folded portion 115 may be formed by folding one side of the casing 112 in a state in which the electrode assembly 113 is disposed on the casing 112, and the terrace portion 117 may be formed by sealing a remaining region of the casing 112 excluding the folded portion 115 in a state in which both ends of the casing 112 oppose each other.

For example, the folded portion 115 may be folded 180° along a first bent line C1 and then folded again along a second bent line C2, and the adhesive member 118 may attach a plurality of portions of the folded portion 115 to each other to fix a folded structure of the folded portion 115. The folded structure of the folded portion 115 may allow the casing 112 to seal the electrode assembly 113 while minimizing a volume of the casing 112.

However, the folded portion 115 may generate stress in the folded portion 115, and thus the probability of defect occurrence in the folded portion 115 of the casing 112 may be higher than that in other regions of the casing 112. A defect in the folded portion 115 may degrade sealing performance of the electrode assembly 113 of the casing 112. Accordingly, it may be crucial to detect a defect in the folded portion 115.

For example, the casing 112 including the folded portion 115 may include an embedded metal layer 115a, and may further include a first insulating layer 115p and a second insulating layer 115s. Each of the first and second insulating layers 115p and 115s may be formed of plastic such as nylon, polyethylene terephthalate (PET), or polypropylene (PP), but the present disclosure is not limited thereto. The metal layer 115a may be disposed between the first insulating layer 115p and the second insulating layer 115s to maintain a shape of the casing 112. When a specific portion A of the metal layer 115a is normal A-1, the metal layer 115a may prevent permeation of foreign matter (for example, moisture). When a crack A-2 occurs in the specific portion A of the metal layer 115a, foreign matter (for example, moisture) may permeate into the electrode assembly 113 through the crack A-2 of the metal layer 115a. Moisture permeating into the electrode assembly 113 may cause a mixture (for example, lithium oxide) of an electrolyte component (for example, lithium) and a component (for example, aluminum) of the metal layer 115a, and may cause corrosion of the electrode assembly 113. As the mixture (for example, lithium oxide) gradually grows or corrosion gradually progresses, the battery cell 110 may gradually swell. The swelling of the battery cell 110 may degrade the safety of the battery cell 110.

The magnetic field outputter 210 may be configured to output a magnetic field to the folded portion 115 of the casing 112 of the battery cell 110. The property measuring instruments 220a and 220b may be configured to measure a property according to the magnetic field of the folded portion 115. The controller 230 may be configured to generate defect information of the folded portion 115, based on measurement results of the property measuring instruments 220a and 220b. Accordingly, the apparatus according to an embodiment of the present disclosure may efficiently detect a defect in the folded portion 115 even without using detection equipment (for example, equipment using X-rays or polarized light) that is large in size, high in unit price, or time-consuming, even when the folded portion 115 is not unfolded or disassembled.

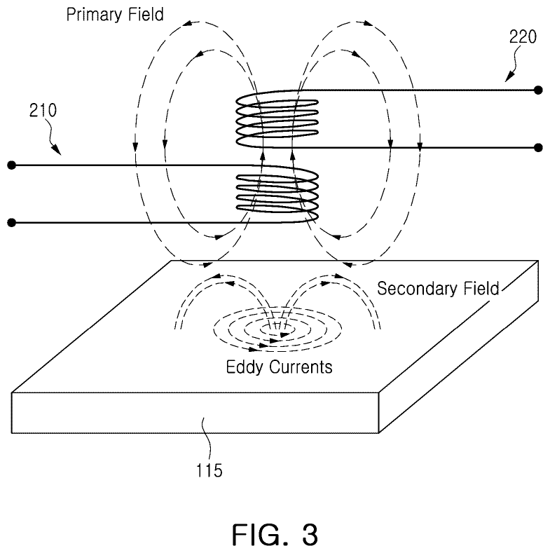

FIG. 3 is a diagram illustrating a configuration in which an apparatus and method for detecting a defect in a folded portion of a casing of a battery cell output a magnetic field to generate an eddy current, according to an embodiment of the present disclosure. Referring to FIGS. 1 and 3, a primary field, output by the magnetic field outputter 210, may pass through the metal layer 115a of the folded portion 115, and a change in the magnetic field (for example, a change in a value of an alternating current (AC) signal) may form an eddy current in the metal layer 115a. The eddy current may form a secondary field, and the property measuring instrument 220 may measure the eddy current by measuring the secondary field.

A crack in the metal layer 115a of the folded portion 115 may interfere with formation of an eddy current, thereby causing a decrease in the eddy current. That is, sheet resistance at a coordinate at which a crack is positioned in the metal layer 115a may increase. A property according to the primary field of the folded portion 115 may include sheet resistance of the folded portion 115, and the property measuring instrument 220 may measure sheet resistance of the folded portion 115. For example, a magnitude of a current (or an amplitude of an AC), flowing through the property measuring instrument 220, may be determined by the secondary field according to the eddy current of the folded portion 115, such that the property measuring instrument 220 may measure the eddy current of the folded portion 115 and the sheet resistance of the folded portion 115.

For example, the battery cell 110 may be disposed between the magnetic field outputter 210 and the property measuring instrument 220a, and the property measuring instrument 220a may have one surface on which the battery cell 110 is disposed. The property measuring instrument 220a may be a sheet resistance measuring instrument, but the present disclosure is not limited thereto. For example, at least one fixed set of the pickup coil 221 and the measurement circuit 222 in FIG. 2 may be disposed in the property measuring instrument 220a, and the property measuring instrument 220a may include a housing surrounding the fixed set. The battery cell 110 may be in direct contact with the housing of the property measuring instrument 220a, at least a portion of the housing may include an insulating layer to allow a magnetic field to pass therethrough, and another portion of the housing may include a terminal to be electrically connected to or communicate with the controller 230.

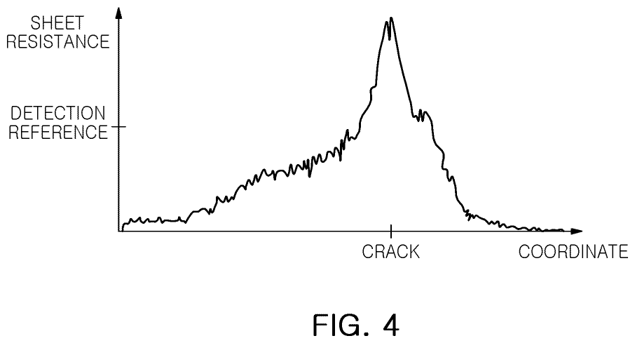

FIG. 4 is a graph illustrating a result of measuring, by an apparatus and method for detecting a defect in a folded portion of a casing of a battery cell, sheet resistance at each coordinate of the folded portion, according to an embodiment of the present disclosure. Referring to FIGS. 1 and 4, the magnetic field outputter 210 may output a magnetic field to a plurality of coordinates of the folded portion 115 according to movement of one of the magnetic field outputter 210 and the battery cell 110, and the controller 230 may generate defect information of the folded portion 115, based on whether there is a coordinate having a sheet resistance value greater than a reference value (detection reference), among the plurality of coordinates. The defect information of the folded portion 115 may include information on detection of a crack in the metal layer 115a. For example, the reference value (detection reference) may be pre-stored in the controller 230, and may vary depending on a type or an environment (for example, temperature) of the battery cell 110.

The controller 230 may control movement of one of the magnetic field outputter 210 and the battery cell 110. For example, the controller 230 may control movement of the magnetic field outputter 210 by transmitting a movement control signal to an actuator moving an induction coil 211 of the magnetic field outputter 210 in a Y-direction. For example, the actuator may be implemented as a linear actuator for implementing linear motion of the induction coil 211. For example, the controller 230 may pre-store movement path information, and may generate the movement control signal such that the induction coil 211 does not deviate from the movement path, based on the movement path information. Movement of the induction coil 211 may be replaced, depending on a design thereof, by arranging a plurality of induction coils 211 in the Y-direction.

FIG. 4 illustrates a sheet resistance curve in which a sheet resistance value at a specific coordinate of the folded portion (115 in FIG. 1) is greater than the detection reference due to a crack occurring in the specific coordinate, the controller (230 in FIG. 1) may generate information on detection of a crack in the folded portion. When no crack occurs in the folded portion (115 in FIG. 1), sheet resistance values at all coordinates of the sheet resistance curve may not be greater than the detection reference, and the controller (230 in FIG. 1) may generate information on non-detection of a crack in the folded portion (230 in FIG. 1). The controller (230 in FIG. 1) may map a distribution of sheet resistance values at the plurality of coordinates of the folded portion (115 in FIG. 1), as illustrated in the graph in FIG. 4, and may generate mapping information as the defect information of the folded portion.

The folded portion 115 may be positioned only at one edge of the casing 112, such that the magnetic field outputter 210 may output a magnetic field to the plurality of coordinates of the folded portion 115 according to one-dimensional movement (for example, movement only in the Y-direction) of one of the magnetic field outputter 210 and the battery cell 110. Accordingly, a movement path of one of the magnetic field outputter 210 and the battery cell 110 may be reduced, such that a period of time required for the apparatus and method for detecting a defect in the folded portion of the battery cell 110 may be reduced. The folded portion 115 may not overlap the electrode lead 114 and the electrode assembly 113 in an X-direction, such that a movement path of the magnetic field outputter 210 may not overlap the electrode lead 114 and the electrode assembly 113 in the X-direction. For example, the controller 230 may move the induction coil 211 of the magnetic field outputter 210 only in the Y-direction, based on movement path information set for one-dimensional movement of the induction coil 211.

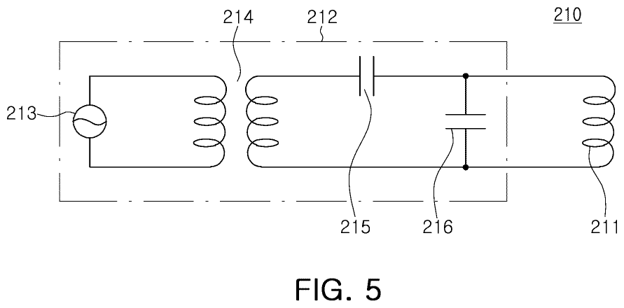

FIG. 5 is a circuit diagram illustrating a circuit structure of a magnetic field outputter included in an apparatus for detecting a defect in a folded portion of a casing of a battery cell according to an embodiment of the present disclosure. Referring to FIGS. 1 and 5, the magnetic field outputter 210 may include an induction coil 211 and an induction current generator 212, and the induction current generator 212 may include an AC power source 213, a transformer 214, and a plurality of capacitors 215 and 216. The AC power source 213 may provide an AC voltage having a predetermined frequency, and at least one of a plurality of capacitors 215 and 216 may cause LC resonance with the induction coil 211, and the transformer 214 may be connected between the AC power source 213 and the induction coil 211 to prevent the LC resonance from adversely affecting the AC voltage provision of the AC power source 213. An AC current having a predetermined frequency may flow through the induction coil 211 and correspond to a magnetic field of the induction coil 211.

Referring back to FIGS. 2 and 3, a property according to a primary field of the folded portion 115 may include an eddy current property according to the primary field of the folded portion 115, and the property measuring instrument 220b may include a pickup coil 221 having inductance for measuring the eddy current property according to the magnetic field of the folded portion 115. The inductance of the pickup coil 221 may be determined by a combination of self inductance and mutual inductance, and the mutual inductance of the pickup coil 221 may vary by an eddy current of the folded portion 115. Accordingly, the measurement circuit 222 of the property measuring instrument 220b may measure the eddy current of the folded portion 115 by measuring the inductance of the pickup coil 221, and may measure sheet resistance of the folded portion 115. The controller 230 may detect a defect in the folded portion 115, based on the inductance of the pickup coil 221.

For example, the controller 230 may also move the pickup coil 221 when moving the induction coil 211 of the magnetic field outputter 210. Accordingly, the induction coil 211 and the pickup coil 221 may always overlap each other in an X-direction. The induction coil 211 and the pickup coil 221 may be implemented to be substantially the same (for example, having the same number of windings and the same winding diameter), but the present disclosure is not limited thereto. Movement of the pickup coil 221 may be replaced, depending on a design thereof, with arranging a plurality of pickup coils 221 in a Y-direction, and the plurality of pickup coils 221 may be arranged in the Y-direction in the property measuring instrument 220a in FIG. 1.

The property measuring instrument 220b may further include a measurement circuit 222 measuring a resonance frequency of LC resonance based on the inductance of the pickup coil 221. The resonance frequency of the LC resonance may be determined by a combination of the inductance of the pickup coil 221 and a capacitance of a capacitor in the measurement circuit 222, such that the resonance frequency of the LC resonance may correspond to the inductance of the pickup coil 221 (dependent on the eddy current of the folded portion 115). Accordingly, the controller 230 may detect a defect in the folded portion 115, based on the resonance frequency of the LC resonance based on the inductance of the pickup coil 221.

For example, the measurement circuit 222 may generate a sampling signal having the resonance frequency based on the inductance of the pickup coil 221 when the folded portion 115 is normal, and may measure an amplitude of the sampling signal. When the amplitude of the sampling signal is greatly changed, the controller 230 may generate information indicating that a defect is present in the folded portion 115.

For example, at least a portion of the controller 230 may be implemented as a computing system (including a processor, memory, storage, an input/output device, and a communication device), such as a microcontroller. For example, at least a portion of the controller 230 may be implemented to perform only predefined operations, such as a programmable logic controller or an embedded system. For example, the controller 230 may transmit the generated information to a process control system such as a manufacturing execution system (MES), output (for example, display) the information to a user, or remotely transmit the information to a terminal device of the user. Depending on a design thereof, another portion of the controller 230 and/or the measurement circuit 222 may be implemented as a digital multimeter, or may include an analog measurement circuit (for example, a sampling circuit, a buffer circuit, an amplification circuit, or an analog-to-digital conversion circuit).

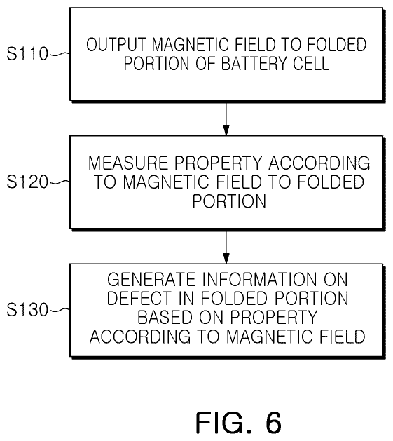

FIG. 6 is a flowchart illustrating a method for detecting a defect in a folded portion of a casing of a battery cell according to an embodiment of the present disclosure. Referring to FIGS. 1 and 6, the method according to an embodiment of the present disclosure may include an operation (S110) of outputting a magnetic field to a folded portion 115 of a casing 112 of a battery cell 110, an operation (S120) of measuring a property according to the magnetic field, and an operation (S130) of generating defect information of the folded portion 115, based on the property according to the magnetic field. Accordingly, the method according to an embodiment of the present disclosure may efficiently detect a defect in the folded portion 115 even without using detection equipment (for example, equipment using X-rays or polarized light) that is large in size, high in unit price, or time-consuming, even when the folded portion 115 is not unfolded or disassembled.

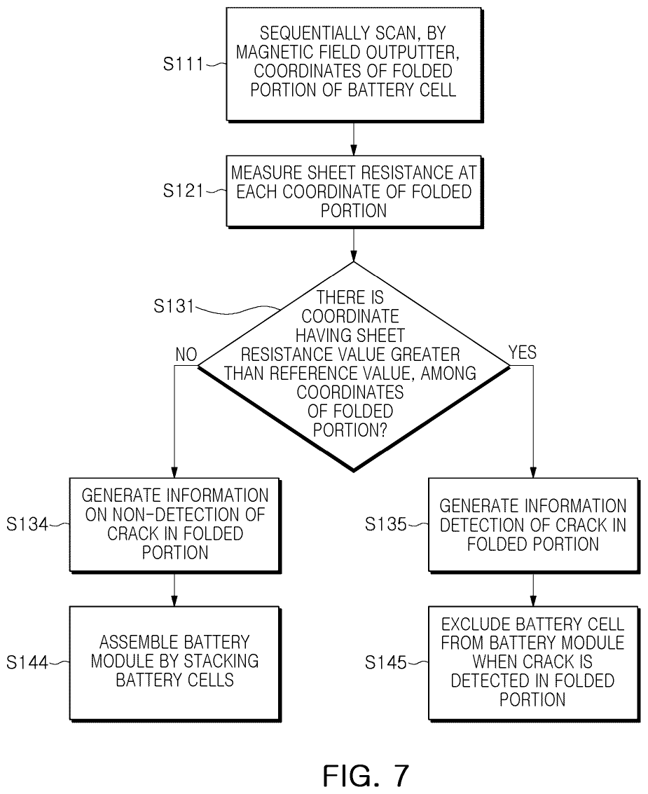

FIG. 7 is a flowchart illustrating a configuration in which an apparatus and method for detecting a defect in a folded portion of a casing of a battery cell detect a crack in the folded portion, based on a result of measuring sheet resistance at each coordinate of the folded portion, according to an embodiment of the present disclosure, and

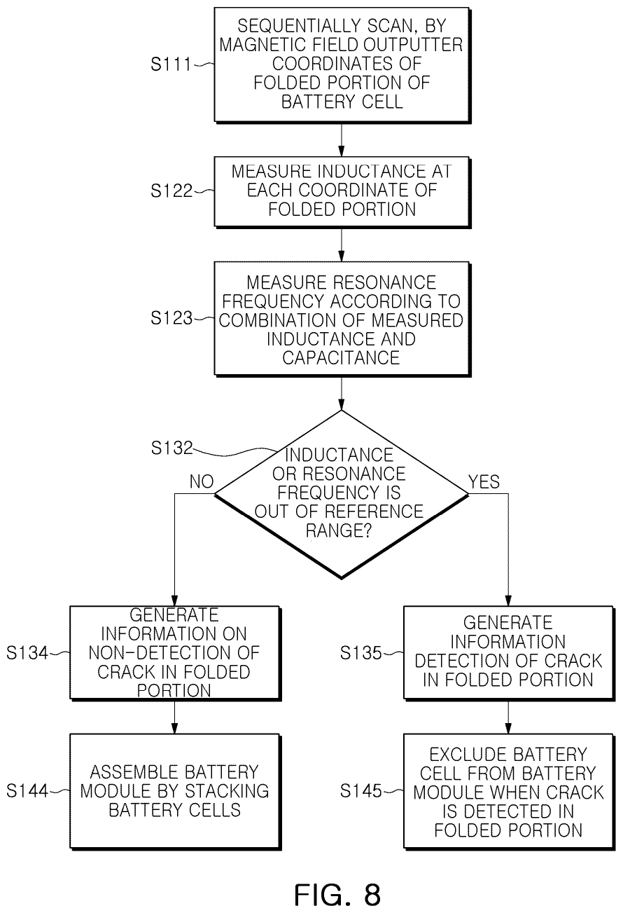

FIG. 8 is a flowchart illustrating a configuration in an apparatus and method for detecting a defect in a folded portion of a casing of a battery cell detect a crack in the folded portion, based on a result of measuring inductance at each coordinate of the folded portion, according to an embodiment of the present disclosure.

Referring to FIGS. 1, 7, and 8, the outputting operation of the method according to an embodiment of the present disclosure (S110 in FIG. 6) may include sequentially scanning, by the magnetic field outputter 210, a plurality of coordinates of the folded portion 115 of the battery cell 110 (S111). The scanning may mean outputting a magnetic field with respect to the plurality of coordinates of the folded portion 115 according to one-dimensional movement (for example, movement only in a Y-direction) of one of the magnetic field outputter 210 and the battery cell 110.

Referring to FIGS. 1 and 7, the measuring operation (S120 in FIG. 6) of the method according to an embodiment of the present disclosure may include measuring, by the property measuring instrument 220a, sheet resistance at each coordinate of the folded portion 115 (S121). That is, the property according to the magnetic field of the measuring operation (S120 in FIG. 6) may include the sheet resistance of the folded portion 115.

The generating operation of the method according to an embodiment of the present disclosure (S130 in FIG. 6) may include generating defect (for example, crack) information of the folded portion 115, based on whether there is a coordinate having a sheet resistance value greater than a reference value, among the plurality of coordinates of the folded portion 115 (S131). When a crack is detected in a folded portion of a battery cell, the battery cell may be excluded from a battery module (including a plurality of battery cells) (S145). When no crack occurs in the folded portion 115, sheet resistance values at the plurality of coordinates of the folded portion 115 may not be greater than the reference value, the controller 230 may generate information on non-detection of a crack in the folded portion 115 (S134), and may assemble a battery module by stacking a plurality of battery cells including the corresponding battery cell (S144).

Referring to FIGS. 2 and 8, the measuring operation (S120 in FIG. 6) of the method according to an embodiment of the present disclosure may include measuring inductance of the pickup coil 221 for measuring an eddy current property according to a magnetic field of the folded portion 115 (S122), and may further include measuring a resonance frequency of LC resonance based on the inductance of the pickup coil 221 for measuring the eddy current property according to the magnetic field of the folded portion 115 (S123). That is, the property according to the magnetic field of the measuring operation (S120 in FIG. 6) may include the eddy current property according to the magnetic field of the folded portion 115.

The generating operation of the method according to an embodiment of the present disclosure (S130 in FIG. 6) may include generating defect (for example, crack) information of the folded portion 115, based on whether there is a coordinate having inductance or resonance frequency that is out of a reference range (S132), among the plurality of coordinates of the folded portion 115. When a crack is detected in a folded portion of a battery cell, the battery cell may be excluded from a battery module (including a plurality of battery cells) (S145).

According to an embodiment of the present disclosure, an apparatus and method for detecting a defect in a folded portion of a casing of a battery cell may efficiently detect a defect in the folded portion without unfolding or disassembling the folded portion, and without using detection equipment (for example, equipment using X-rays or polarized light) that is large in size, high in unit price, or time-consuming.

Only specific examples of implementations of certain embodiments are described. Variations, improvements and enhancements of the disclosed embodiments and other embodiments may be made based on the disclosure of this patent document.

What is claimed is:

1. An apparatus for detecting a defect in a folded portion of a casing of a battery cell, the apparatus comprising:
a magnetic field outputter configured to output a magnetic field to the folded portion of the casing of the battery cell;
a property measuring instrument configured to measure a property of the folded portion according to the magnetic field; and
a controller configured to generate defect information of the folded portion, based on a measurement result of the property measuring instrument.

2. The apparatus of claim 1, wherein the magnetic field outputter is configured to output a magnetic field with respect to a plurality of coordinates of the folded portion according to movement of the magnetic field outputter or the battery cell.

3. The apparatus of claim 1, wherein
the folded portion is positioned at one edge of the casing, and
the magnetic field outputter is configured to output a magnetic field with respect to a plurality of coordinates of the folded portion according to one-dimensional movement of the magnetic field outputter or the battery cell.

4. The apparatus of claim 1, wherein
the casing includes an embedded metal layer, and
the defect information of the folded portion includes information on detection of a crack in the metal layer.

5. The apparatus of claim 1, wherein
the property according to the magnetic field includes sheet resistance of the folded portion, and
the property measuring instrument is configured to measure the sheet resistance of the folded portion.

6. The apparatus of claim 5, wherein
the magnetic field outputter is configured to output a magnetic field with respect to a plurality of coordinates of the folded portion according to movement of the magnetic field outputter or the battery cell, and
the controller is configured to generate defect information of the folded portion, based on whether there is a coordinate having a sheet resistance value greater than a reference value, among the plurality of coordinates.

7. The apparatus of claim 6, wherein
the battery cell is disposed between the magnetic field outputter and the property measuring instrument, and
the property measuring instrument has one surface on which the battery cell is disposed.

8. The apparatus of claim 1, wherein
the property according to the magnetic field includes an eddy current property of the folded portion according to the magnetic field, and
the property measuring instrument includes a pickup coil having inductance for measuring the eddy current property of the folded portion according to the magnetic field.

9. The apparatus of claim 8, wherein the property measuring instrument further includes a measurement circuit configured to measure a resonance frequency of LC resonance based on the inductance of the pickup coil.

10. A method of detecting a defect in a folded portion of a casing of a battery cell, the method comprising:
outputting a magnetic field to the folded portion of the casing;
measuring a property of the folded portion according to the magnetic field; and
generating defect information of the folded portion, based on the property according to the magnetic field.

11. The method of claim 10, wherein
the folded portion is positioned at an edge of the casing, and
the outputting includes sequentially scanning a plurality of coordinates of the folded portion.

12. The method of claim 11, wherein
the casing includes an embedded metal layer, and
the defect information of the folded portion includes information on detection of a crack in the metal layer.

13. The method of claim 12, wherein
the property according to the magnetic field includes sheet resistance of the folded portion, and
the generating includes generating defect information of the folded portion, based on whether there is a coordinate having a surface resistance value greater than a reference value, among the plurality of coordinates.

14. The method of claim 12, wherein
the property according to the magnetic field includes an eddy current property of the folded portion according to the magnetic field, and
the measuring includes measuring inductance of a pickup coil for measuring the eddy current property of the folded portion according to the magnetic field.

15. The method of claim 12, wherein
the property according to the magnetic field includes an eddy current property of the folded portion according to the magnetic field, and
the measuring includes measuring a resonance frequency of LC resonance based on inductance of a pickup coil for measuring the eddy current property of the folded portion according to the magnetic field.
